(19) United States
(12) Patent Application Publication
(10) Pub. No.: US 2009/0089876 A1
(43) Pub. Date: Apr. 2, 2009

(54) APPARATUS SYSTEM AND METHOD FOR VALIDATING USERS BASED ON FUZZY LOGIC

(76) Inventors: Jamie Lynn Finamore, Raleigh, NC (US); Harriss Christopher Neil Ganey, Cary, NC (US); Aaron Michael Stewart, Raleigh, NC (US)

Correspondence Address: Kunzler & McKenzie, 8 EAST BROADWAY, SUITE 600, SALT LAKE CITY, UT, 84111, US

(21) Appl. No.: 11/864,077

(22) Filed: Sep. 28, 2007

(51) Int. Cl. G06F 7/04

(52) U.S. Cl. 726/21

(57) ABSTRACT

An apparatus, system, and method are disclosed for validating users based on fuzzy logic. An interface with security questions is presented to a user who requires authentication. A typical scenario is authentication for password recovery. The interface comprises security questions for the user to answer. The security questions may be limited or unlimited response questions. The answers to the security questions are either scored using fuzzy logic, which may attribute a value between “1” and “0” based on similarity with the original, correct answer; or scored using digital logic. When fuzzy logic scoring is used, a similarity score is computed for each answer. The similarity score is compared against a similarity score threshold to either grant or deny access. An average similarity score is also computed for all answers and compared against an average similarity score threshold to either grant or deny access.

### BACKGROUND OF THE INVENTION

1. Field of the Invention

This invention relates to authenticating users and more particularly relates to validating users based on passphrases evaluated using fuzzy logic.

2. Description of the Related Art

Fuzzy logic deals with reasoning that is approximate rather than precise. That is, instead of having a correct answer indicated by returning a “1” or an incorrect answer indicated by returning a “0,” a number in between “0” or “1” may be returned to indicate approximate correctness. The use of fuzzy logic allows a response that is close to the correct response, but not exact, to get by a “gatekeeper” if it meets a predefined threshold.

A computing environment frequently requires users to authenticate in order to access particular resources. An authenticating “token” is required to authenticate a user. The authenticating “token” may be dispensed in response to presentation of credentials such as a smart card, fingerprint, or the combination of a username and password, to name a few. A smart card and fingerprint have authenticating credentials “built in,” thus a user does not need to remember them. However, for some other credentials, such as the username and password combination, the user is required to remember them for each use.

When the user cannot remember the username or password, a procedure for recovering the username and password may be provided to the user. The procedure typically includes asking at least one security question to ensure the user requesting the username or password is the actual user. The security question is typically presented to the user, usually when a user's account is created, and the user provides the answer. Examples of these questions include asking the color of the user's first car, where they went to high school, or their first pet's name. There is no “forgiveness” in answering these questions. The answer, if not an exact match, will fail. To prevent forgetting the security answer, some users will enter a very simple and inaccurate security answer, such as using the name of their pet or favorite color, for each security question. As a result, security may be compromised.

### SUMMARY OF THE EMBODIMENTS

The various embodiments presented herein have been developed in response to the present state of the art, and in particular, in response to the problems and needs in the art that have not yet been fully solved by currently available user authentication systems. Accordingly, various apparatus, systems, and methods for validating users based on fuzzy logic are presented herein that overcome many or all of the above-discussed shortcomings in the art. Details regarding the various embodiments described herein are simply illustrative and should not be used to limit the scope of the invention as defined by the claims.

An apparatus is provided with a logic unit containing a plurality of modules configured to functionally execute the necessary steps of validating users based on fuzzy logic. These modules in the described embodiments include a user interface module, a scoring module, and an access control module.

The apparatus, in one embodiment, is configured to provide security questions to a user. The security questions may include limited response questions. A limited response question is a question which will have a limited number of possible answers. For example, asking what is the color of something is a limited response question because the answers are limited to colors with names. The security questions may include unlimited response questions. An unlimited response question is a question which has a relatively unlimited number of possible answers such as “What is your favorite song?”

The apparatus may be configured to receive answers from the user for the security questions. In one embodiment, the answers are typed in by the user. If the answer relates to a limited response question, in certain embodiments, the apparatus may be configured to provide the user with each possible response via a selection mechanism such as a user interface control. The answer may be selected by the user via the selection mechanism. The limited response questions may be limited to one hundred possible responses. In certain embodiments, an unlimited response question uses a selection mechanism. In one embodiment, the selection mechanism may effectively convert an unlimited response question into a limited response question by providing a limited set of responses to the user.

The apparatus is further configured, in one embodiment, to compute a similarity score between each received answer and a known answer. The apparatus may be configured to compute the similarity score for each answer. An answer may be digitally scored with either a completely correct value, which might be “1,” or a completely incorrect value, which might be “0.” An answer may also undergo fuzzy scoring and score a value between “1” and “0” depending on how close the answer is to the completely correct value. In this case, the similarity score represents the similarity between the answer and the known correct answer.

The apparatus may be configured to reject user access if the similarity score is below a similarity threshold. The similarity threshold is the minimum similarity score required for a particular question. In one embodiment, the apparatus rejects user access if the average similarity score is below an average similarity threshold. The average similarity threshold is the minimum average similarity score required to gain access. The apparatus may grant user access if the average similarity threshold is reached or exceeded.

Various systems are also presented to validate users based on fuzzy logic. One system, in one embodiment, includes an authenticating device configured to provide security questions to a user, receive answers from the user, compute a similarity score between each received answer and a known answer, and reject user access if the similarity score is below a similarity threshold.

Various methods are also presented for validating users based on fuzzy logic. The methods in certain disclosed embodiments substantially include the steps necessary to carry out the functions presented above with respect to the operation of the described apparatus and system. In one embodiment, a method includes providing security questions to a user, receiving answers from the user, computing a similarity score between each received answer and a known answer, and rejecting user access if the similarity score is below a similarity threshold.

Reference throughout this specification to features, advantages, or similar language does not imply that all of the features and advantages that may be realized with the various embodiments presented herein should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages will become more fully apparent from the following description and appended claims, or may be learned by the practice of the various embodiments as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic flow chart illustrating a typical prior art method for validating users;

FIG. 2 is a schematic block diagram illustrating one embodiment of a system for validating users based on fuzzy logic in accordance with the present invention;

FIG. 3 is a schematic flow chart illustrating one embodiment for validating users based on fuzzy logic in accordance with the present invention;

FIG. 4 is a schematic flow chart illustrating one embodiment of a method for displaying security questions in accordance with the present invention;

FIG. 5 is a schematic flow chart illustrating one embodiment of a method for validating users based on fuzzy logic in accordance with the present invention;

FIG. 6 is a schematic flow chart diagram illustrating one embodiment of a method for assigning security questions and answers to users in accordance with the present invention; and

FIGS. 7a and 7b are depictions of selection controls including legitimate responses to a security question in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

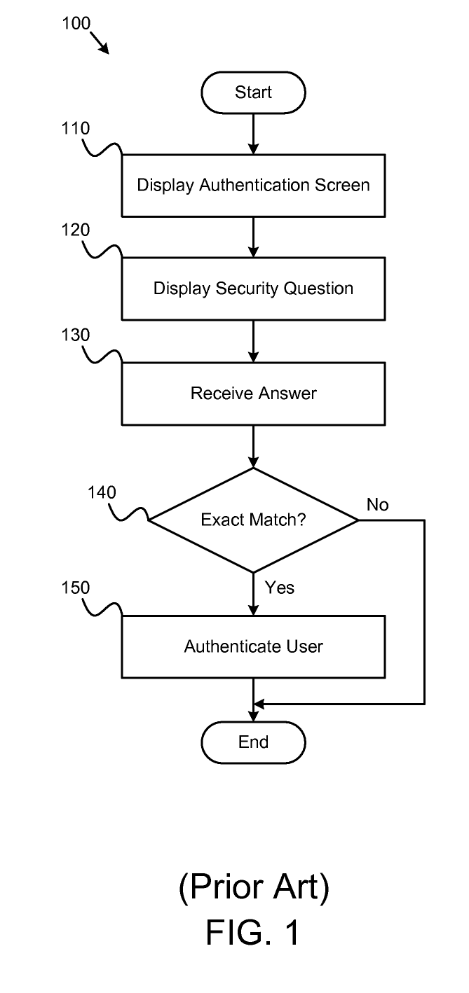

FIG. 1 depicts a prior art method for recovering a username or password. The method 100 includes displaying 110 an authentication screen, displaying 120 a security question, receiving 130 an answer, ascertaining 140 whether the answer is an exact match, and authenticating 150 the user. The depicted method 100 is a prior art method, which does not use fuzzy logic, for authenticating users.

Displaying 110 an authentication screen may include presenting a form to the user. The user may access the authentication screen if the user requires identity validation. One situation where the user may need identity validation is to recover a forgotten password. Displaying 110 may occur in combination with displaying 120 a security question, which may be presented in the form. In one embodiment, displaying 120 includes displaying more than one security question. Receiving 130 an answer may include transmitting data entered by the user to an authenticating device. In one embodiment, receiving 130 may include receiving answers for one or more security questions. Ascertaining 140 whether the security answer is an exact match may include comparing the received answer with a known, correct answer. The known correct answer may have been supplied by the user at the time the account containing the credentials was created. In one embodiment, ascertaining 140 includes comparing received answers for more than one security question, with known, correct answers.

In one embodiment, if the answer is not an exact match, then the method ends without authenticating the user. If the answer is an exact match, then the method continues to authenticating 150 the user. Authenticating 150 the user may include providing the user with a forgotten credential. In one embodiment, the forgotten credential is transmitted to the user upon authentication.

The prior art method 100 may include displaying multiple security questions. Every security question displayed requires an answer that is an exact match to the known, correct answer. For example, if the answer was entered in singular form, but the known, correct answer was the plural form of the same answer, then the answer would fail. To avoid forgetting the answers, the user may enter simple and often incorrect answers to the security questions at account creation. For example, if there are three questions, the user may enter “a,” “b,” and “c,” for the answers, respectively. Similarly, to avoid forgetting the answers to security questions, the user may enter the same answer for all questions. A security consideration is created when the user implements an approach like entering simple, incorrect answers or the same answers, among other techniques. Techniques such as these are exploited by security attacks because they are commonly used and easy to implement in an attack.

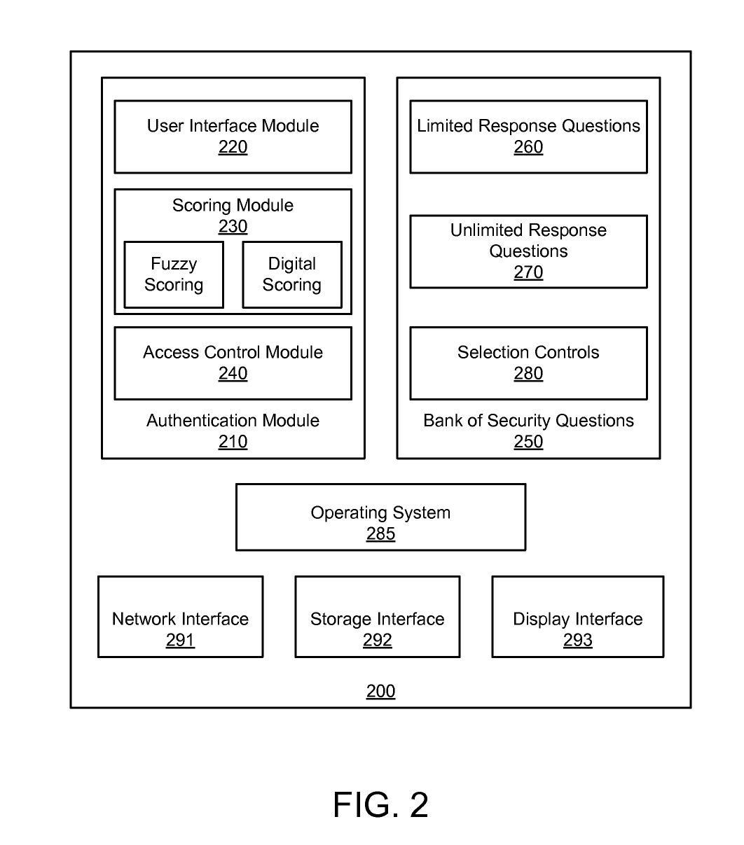

FIG. 2 depicts one embodiment of a system 200 for validating users based on fuzzy logic in accordance with the present invention. As depicted, the system 200 includes an authentication module 210, a user interface module 220, a scoring module 230, an access control module 240, a bank of security questions 250, limited response security questions 260, unlimited response security questions 270, response question selection controls 280, an operating system 285, a network interface 291, a storage interface 292, and a display interface 293. The depicted system 200 enables user validation using fuzzy logic. In one embodiment, the system 200 functions as an authenticating device.

In the depicted embodiment, the authentication module 210 comprises the user interface module 220, the scoring module 230, and the access control module 240. In one embodiment, any of the depicted modules may reside in a different computing device capable of communicating with the authentication module 210. The operating system 285 and network interface 291 may enable communications with the different computing device. The storage interface 292 may enable communications with one or more storage devices, and the display interface 293 may enable the display of information to a system administrator or the like.

The user interface module 220 is configured to provide one or more security questions from the bank of security questions 250 to a user. The provided security questions may be any combination of limited response questions 260 and unlimited response questions 270. The provided security questions may be pre-selected by the user when initially creating a username and password or other type of account credentials. The user interface module 220 may display a form to the user to facilitate the user's entry of information. In one embodiment, the user interface module 220 is configured to receive a set of answers from the user corresponding to the provided security questions.

Unlimited response questions 270 are questions that have a relatively unlimited number of possible answers. Limited response questions 260 are questions with a relatively limited number of possible answers. For example, a limited response question might ask the user to enter the user's favorite color. A question about colors, such as this, has a limited number of answers since the answer is limited to colors with actual names.

In one embodiment, the user interface module 220 displays a response selection control 280 for a question 260 or 270. A response selection control 280 may provide the user with legitimate responses to answer the security question. For example, if the question asked what the user's favorite color was, the associated response selection control may be a color wheel, wherein the user could select a legitimate color response from the color wheel, thus providing a relatively unlimited number of possible responses instead of being limited to colors with names.

In one embodiment, the scoring module 230 is configured to compute a similarity score between each answer and a known correct answer. A security response question may have a digitally scored answer, or an answer with fuzzy scoring. The scoring module 230 may be configured to score the digitally scored answer as a “1” or “0,” and the fuzzy scoring answer with a value between and including “1” and “0” depending on similarity to the known, correct answer. In one embodiment, the similarity score represents the similarity between each answer and a known correct answer. The similarity score may be compared against a similarity threshold, which is a minimum similarity score required for a particular security question. The scoring module 230 may be configured to compute an average similarity score for all the answers received from the user.

The access control module 240 is configured to grant or deny access to the user. In one embodiment, the access control module 240 compares the similarity score obtained by the scoring module 230 with the similarity score threshold. If the similarity score for an answer meets or exceeds the similarity score threshold, then the access control module 240 may grant access. If the similarity score is less than the similarity score threshold, the access control module 240 may deny access.

In one embodiment, the access control module 240 compares the average similarity score obtained by the scoring module 230 with an average similarity score threshold. An average similarity score threshold is a minimum average similarity score required to gain access. If the average similarity score is greater than or equal to the average similarity score threshold, the access control module 240 may grant access. If the average similarity score is less than the average similarity score threshold, the access control module 240 may deny access.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

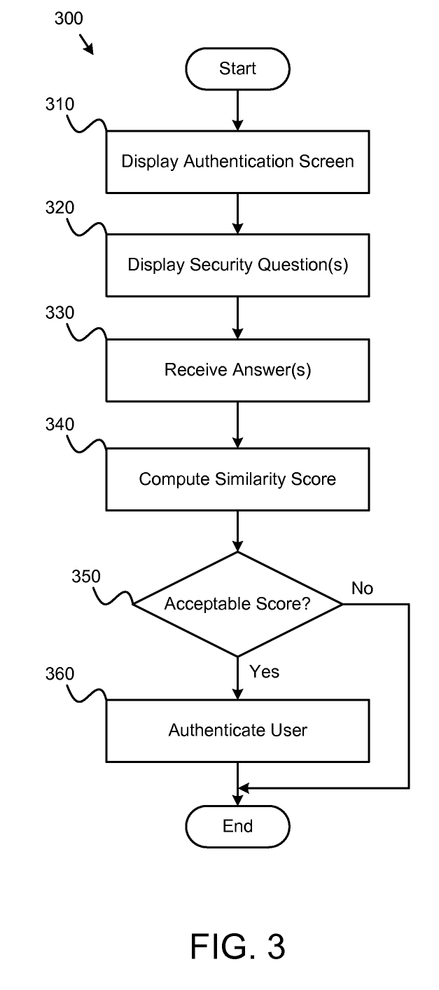

FIG. 3 is a schematic flow chart diagram of a method for validating users based on fuzzy logic in accordance with the present invention. The method 300 includes displaying 310 an authentication screen, displaying 320 security questions, receiving 330 answers, computing 340 a similarity score, ascertaining 350 if the similarity score meets an acceptable range, and authenticating 360 a user. The method 300 demonstrates one embodiment for validating users based on fuzzy logic.

In one embodiment, displaying 310 the authentication screen includes presenting a form to the user. The user may access the authentication screen if the user requires identity validation. One situation where the user may need identity validation is to recover a forgotten password.

Displaying 320 security questions may include presenting the security questions on the authentication screen. Displaying 320 security questions may include displaying limited response questions and unlimited response questions. Any combination of limited response questions and unlimited response questions may be displayed. In one embodiment, when a limited response question is displayed, an associated response selection control is displayed to enable the user to easily select a response. When an unlimited response question is displayed, an associated response selection control may be displayed which includes a limited number of potentially legitimate responses to the security question. Displaying 320 may provide fields for the user to enter answers.

Receiving 330 the answers may include transmitting data entered by the user to an authenticating device. The data may be transmitted over a computer network or over the local system bus of the authenticating device if the user is located at the authenticating device. When the answers are received, computing 340 the similarity score includes comparing the answer for each question with a known answer.

A similarity score may be computed for each answer. The similarity score may be digitally scored. If a digitally scored answer exactly matches the known, correct answer, the similarity score may be a “1.” If the digitally scored answer does not exactly match the known, correct answer, the similarity score may be a “0.” The similarity score may also be scored with fuzzy logic, that is, scored in a range between and including “1” and “0” depending on how similar the answer is to the known answer. An average similarity score is computed by averaging all of the similarity scores.

Ascertaining 350 whether an acceptable score has been met may include comparing the average similarity score with an average similarity score threshold. If the average similarity score is less than the average similarity score threshold, then the user may not be validated and authenticating 360 the user may not occur. If the average similarity score is greater than or equal to the average similarity score threshold, then the user is validated and authenticating 360 the user is granted.

In one embodiment, ascertaining 350 includes comparing the similarity score for a particular answer with an average similarity score threshold. If the similarity score is acceptable, then the user may be validated and authenticating 360 may be granted. Authenticating 360 the user may include providing the user with a forgotten credential. In one embodiment, the forgotten credential is transmitted to the user upon authentication.

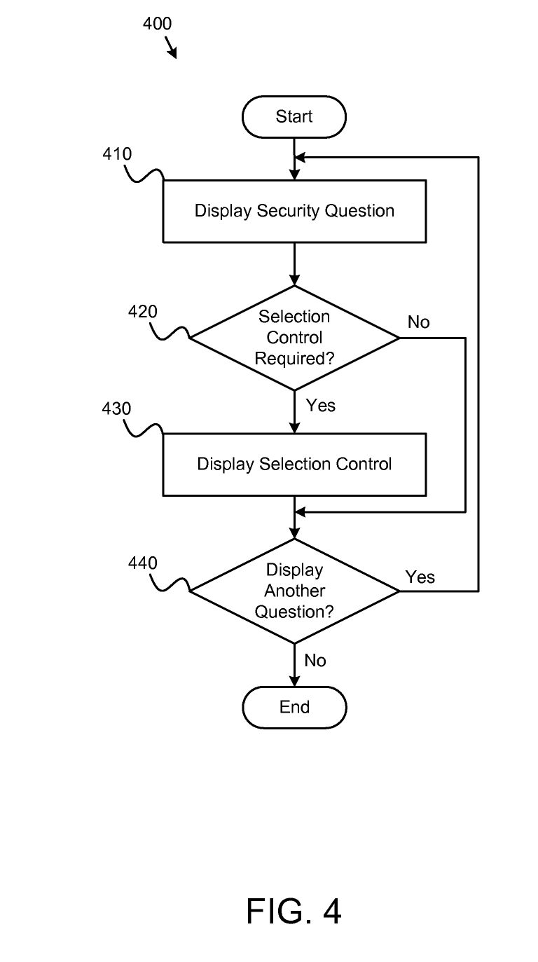

FIG. 4 is a schematic flow chart diagram of a method for displaying security questions in accordance with the present invention. The method 400 includes displaying 410 a security question, ascertaining 420 whether the security question requires a selection control, displaying 430 the selection control, and ascertaining 440 whether another question needs to be displayed. The method 400 demonstrates one embodiment for displaying security questions.

Displaying 410 a security question may include presenting security questions on the authentication screen. Displaying 410 security questions may include displaying limited response questions and unlimited response questions. Any combination of limited response questions and unlimited response questions may be displayed. Displaying 410 security questions may include displaying fields for the user to enter answers.

Ascertaining 420 whether a displayed security question requires a selection control may include analyzing an attribute of the security question. The attribute may associate a selection control with a security question by an identifier. The attribute may indicate that a selection control is not associated with the security question.

In one embodiment, displaying 430 the selection control includes identifying the selection control that is linked with the security question. Displaying 430 may include presenting the selection control to the user on the authentication screen. The selection control may display legitimate responses and allow a user to select a legitimate response to answer the security question.

Ascertaining 440 whether another question needs to be displayed may include analyzing the user's account. In one embodiment, the user selects the security questions at the time a user account is created. In another embodiment, predetermined security questions are presented to the user at the time the user account is created. The security questions may be associated with the user's account at the time the user's account is created. An attribute or other type of identification may be used to identify the security questions associated with the user's account. If another security question remains to be displayed, then the method returns to displaying 410.

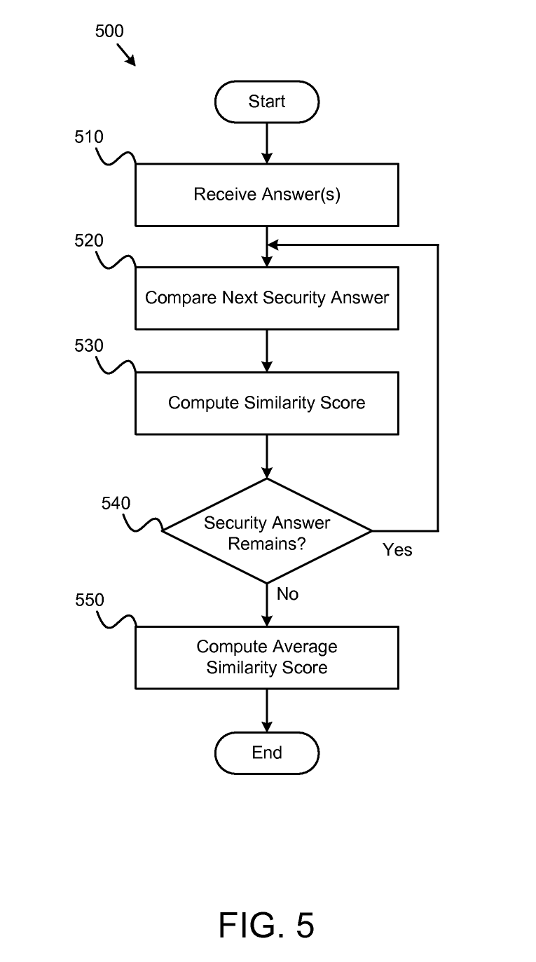

FIG. 5 is a schematic flow chart diagram of a method for validating users based on fuzzy logic in accordance with the present invention. The method 500 includes receiving 510 security answers, comparing 520 a next security answer, computing 530 a similarity score, ascertaining 540 whether a security answer remains to be compared, and computing 550 an average similarity score. The method 500 demonstrates one embodiment for validating users based on fuzzy logic.

In one embodiment, receiving 510 security answers includes transmitting data entered by the user an on authentication screen to an authenticating device. The data may be transmitted over a computer network or over the local system bus of the authenticating device if the user is located at the authenticating device. The security questions being answered may be pre-selected by the user when the user initially created the account seeking to authenticate. Comparing 520 the next security answer may include referencing a known value for the security answer. The known value may reside in a database, an attribute, or any other data repository accessible by the authenticating device. The received security answer may be compared to the known, correct value. In one embodiment, comparing 520 provides a basis for computing 530 the similarity score.

Computing 530 the similarity score may include using digital scoring. If digital scoring is used, then computing 530 may return a “1” or a “0” depending on whether the received security answer matches the known, correct answer. In one embodiment, fuzzy logic is used for computing 530 the similarity score. Using fuzzy logic, if a security answer is neither exactly correct nor incorrect, but similar to a correct answer, then a score between “1” and “0” is attributed to the security answer depending on the security answer's similarity to the known, correct answer.

If ascertaining 540 that a security answer remains to be scored, then the method 500 returns to comparing 520 to compare the next received security answer. If ascertaining 540 that all security answers have been scored, then the method 500 continues to computing 560 the average similarity score. In one embodiment, computing the average similarity score includes averaging all similarity scores received by the user requesting authentication.

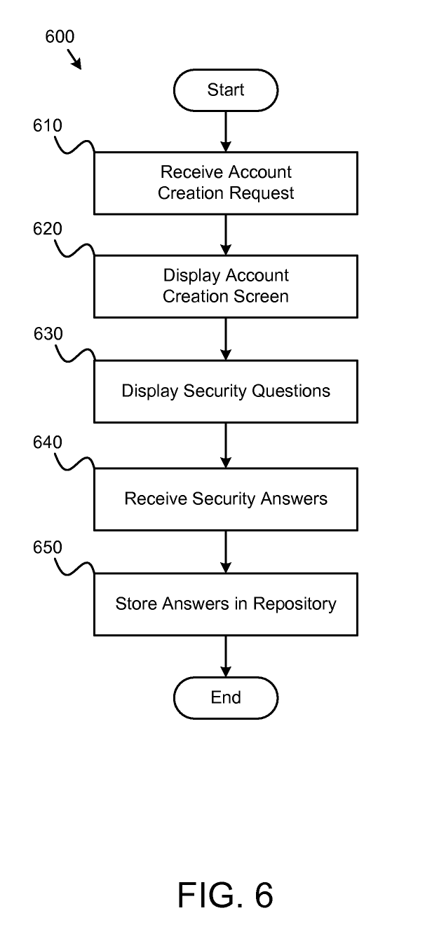

FIG. 6 is a schematic flow chart diagram of a method for assigning security questions and answers to users in accordance with the present invention. The method 600 includes receiving 610 an account creation request from a user, displaying 620 an account creation screen, displaying 630 security questions, receiving 640 security answers, and storing 650 the answers in a repository. The method 600 demonstrates one embodiment for assigning security questions and answers to users.

In one embodiment, receiving 610 the account creation request from the user includes receiving transmitted data over a network or system bus. The account creation information may be used to access a computer network, logon to a computing device, access a website, or the like. Receiving 610 may include the user generating credentials for authentication.

Displaying 620 the account creation screen may include displaying a form to the user. The form may accept credentials from the user, which may be used to create a user account for access control. Displaying 630 security questions may include selecting security questions from a bank of security questions. The security questions may be displayed randomly. In one embodiment, displaying 630 security questions includes selecting a limited number of security questions from the bank of security questions.

Displaying 630 may include allowing the user to select which security questions will be used for recovering forgotten credentials. Displaying 630 may include displaying a field for the user to enter security answers. In one embodiment, displaying 630 includes displaying a selection control showing legitimate responses the user may select as a security answer. An example of a selection control may be a color wheel if the security question limits the security answer to a color. Displaying 630 may include displaying a button to submit the security answers and credentials.

In one embodiment, receiving 640 security answers includes receiving submitted data. Storing 650 answers in the repository may include associating the selected security questions with the user credentials. Storing 650 may include associating the received security answers with the selected security questions. In one embodiment, storing 650 includes attributing a selection control with a selected security question and answer. Storing 650 may include facilitating retrieval of the security questions and security answers when user validation is required.

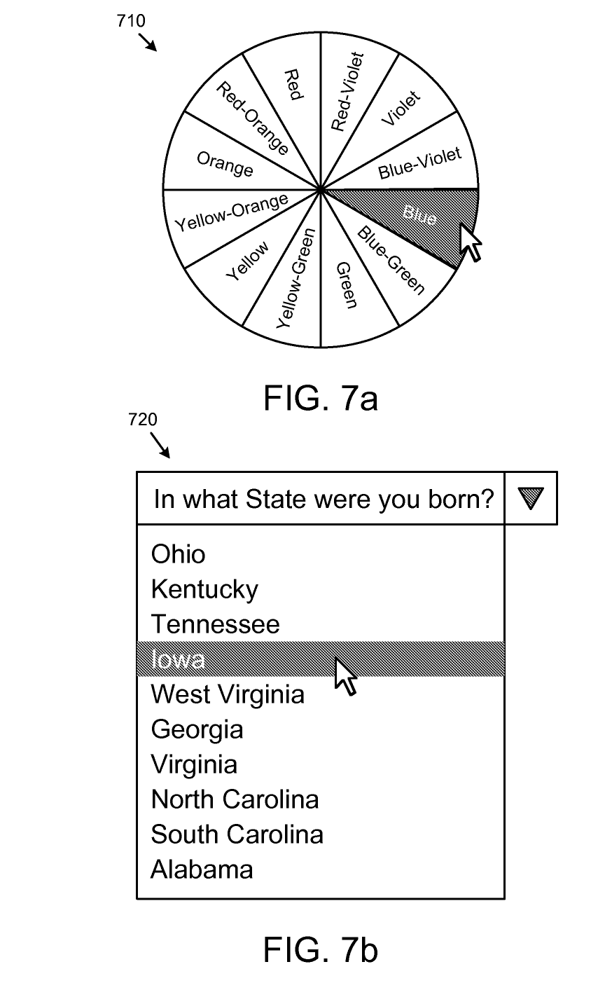

FIG. 7a represents a selection control that may be used to assist a user in selecting a security answer. The depicted selection control 710 is a color wheel with twelve legitimate colors available to the user to be selected. In one embodiment, the selection control 710 has as many as one hundred legitimate responses available to the user. The selection control 710 may be used when the security question demands a color as an answer.

The selection control 710 may be used in combination with fuzzy logic scoring. For example, if the user had initially selected “Blue-Violet” as the known, correct answer for the particular security question and the user selected “Blue” for the answer, the user would score a value in between “0” and “1” because “Blue” is not an exact match to the known, correct answer, but “Blue” does have similarity to the known, correct answer, “Blue-Violet.” In one embodiment, the selection control 710 is used for digital scoring, that is, the correct answer scores a “1” and all other answers score a “0.”

FIG. 7b represents a selection control that may be used to assist a user in selecting a security answer. The depicted selection control 720 is a drop-down menu with ten legitimate responses to a particular security question. In one embodiment, the selection control 720 has the question associated with the selection control as depicted. The selection control 720 may be used with fuzzy scoring or digital scoring. Other selection controls may be used that assist the user in selecting a legitimate response to a security question. For example, a map of the country in which the user was born may be displayed, wherein the map would be divided into areas such as States, regions, Provinces, or the like to allow the user to select the correct answer from the legitimate responses.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a user interface module configured to provide a plurality of security questions to a user, the plurality of security questions comprising at least one limited response question;
the user interface module further configured to receive a plurality of answers from the user corresponding to the plurality of security questions;
a scoring module configured to compute a similarity score between each answer and a corresponding known correct answer, wherein at least one similarity score is a fuzzy similarity score; and
an access control module configured to reject user access if the similarity score is below a similarity threshold.

2. The apparatus of claim 1, wherein the scoring module is further configured to compute an average similarity score for the plurality of answers and reject user access if the average similarity score is below an average similarity threshold.

3. The apparatus of claim 1, wherein the user interface module is further configured to prompt a user to supply the known correct answers for the plurality of security questions.

4. The apparatus of claim 1, wherein at least one security score is a digital security score.

5. The apparatus of claim 1, wherein each limited response question has less than one hundred legitimate responses.

6. The apparatus of claim 1, wherein the user interface module is further configured to provide the user with each legitimate response for a limited response question.

7. A system comprising:
a network interface configured to facilitate communications with a user;
an authentication module configured to:
provide a plurality of security questions to the user, the plurality of security questions comprising at least one limited response question;
receive a plurality of answers from the user corresponding to the plurality of security questions;
compute a similarity score between each answer and a corresponding known correct answer, wherein at least one similarity score is a fuzzy similarity score; and
reject user access if the similarity score is below a similarity threshold.

8. The system of claim 7, wherein the authentication module is further configured to compute an average similarity score for the plurality of answers and reject user access if the average similarity score is below an average similarity threshold.

9. The system of claim 7, wherein the authentication module is further configured to prompt a user to supply the known correct answers for the plurality of security questions.

10. The system of claim 7, wherein at least one security score is a digital security score.

11. The system of claim 7, wherein each limited response question has less than one hundred legitimate responses.

12. The system of claim 7, further comprising a display interface, a storage interface, and an operating system.

13. A computer readable medium tangibly embodying a program of machine-readable instructions executable by a digital processing apparatus to perform operations comprising:
providing a plurality of security questions to a user, the plurality of security questions comprising at least one limited response question;
receiving a plurality of answers from the user corresponding to the plurality of security questions;
computing a similarity score between each answer and a corresponding known correct answer, wherein at least one similarity score is a fuzzy similarity score;
rejecting user access if the similarity score is below a similarity threshold;
computing an average similarity score for the plurality of answers;
rejecting user access if the average similarity score is below an average similarity threshold.

14. The computer readable medium of claim 13, wherein the operations further comprise providing the user with each possible response for a limited response question.

15. A method comprising:
providing a plurality of security questions to a user, the plurality of security questions comprising at least one limited response question;
receiving a plurality of answers from the user corresponding to the plurality of security questions;
computing a similarity score between each answer and a corresponding known correct answer, wherein at least one similarity score is a fuzzy similarity score; and
rejecting user access if the similarity score is below a similarity threshold.

16. The method of claim 15, further comprising computing an average similarity score for the plurality of answers and rejecting user access if the average similarity score is below an average similarity threshold.

17. The method of claim 15, further comprising prompting a user to supply the known correct answer for the plurality of security questions.

18. The method of claim 15, wherein at least one security score is a digital security score.

19. The method of claim 15, wherein each limited response question has less than one hundred legitimate responses.

20. The method of claim 15, further comprising providing the user with each legitimate response for a limited response question.
